(19) United States
(12) Patent Application Publication
(10) Pub. No.: US 2008/0163557 A1
(43) Pub. Date: Jul. 10, 2008

(54) Radiation curable formulations

(75) Inventors: Anthony C. Gaeta, Rockport, NY (US); Gwo Shin Swei, East Amherst, NY (US); Edmund F. Butryn, Grimsby (CA)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Saint-Gobain Abrasives, Inc., Worcester, MA (US)

(21) Appl. No.: 12/004,003

(22) Filed: Dec. 19, 2007

Related U.S. Application Data
(62) Division of application No. 11/594,909, filed on Nov. 8, 2006, now abandoned.
Application No. 11/594,909 is a continuation of application No. 09/952,931, filed on Sep. 14, 2001, now abandoned.
Application No. 09/952,931 is a continuation of application No. 08/971,463, filed on Nov. 17, 1997, now abandoned.
Application No. 08/971,463 is a continuation of application No. 08/626,652, filed on Apr. 2, 1996, now abandoned.

(51) Int. Cl. C09K 3/14

(52) U.S. Cl. 51/295

(57) ABSTRACT

A UV-polymerizable formulation comprising a polymerizable formulation and an aluminum trihydrate filler with a particle size of from 1 to 10 micrometers. The formulation is intended for use in the production of coated abrasives can be used to produce a very much thicker coating if a UV-transparent filler is used.

### RELATED APPLICATION(S)

This application is a divisional of U.S. application Ser. No. 11/594,909, filed Nov. 8, 2006, which is a continuation of U.S. application Ser. No. 09/952,931, filed Sep. 14, 2001, which is a continuation of U.S. application Ser. No. 08/971,463, filed on Nov. 17, 1997, which was a Filewrapper Continuation of U.S. application Ser. No. 08/626,652, filed on Apr. 2, 1996. The entire teachings of the above applications are incorporated herein by reference.

### BACKGROUND OF THE INVENTION

The present invention relates to the production of coated abrasives and particularly to the production of such materials using a formulation comprising a UV-curable binder system.

The use of UV-radiation curable formulations in the preparation of coated abrasives has been taught for many years. One of the earliest examples of this form of binder is described in U.S. Pat. No. 4,773,920 which taught the use of binder grain mixtures curable by radiation-induced free radical polymerization. In U.S. Pat. No. 5,014,468 the problems of UV radiation-induced polymerization are reviewed in the context of coated abrasives. It is pointed out that, in view of the limited penetration of the UV light into a formulation that comprises pigment and/or relatively coarse abrasive particles, UV radiation is somewhat limited in its utility to relatively thin layers.

The problems limiting the applicability of UV-radiation cured polymers in coated abrasives are experienced at their most intense in finishing formulations. These are formulations added to fabric materials to prepare them to receive maker coats in the preparation of coated abrasives. Typically they comprise polymers and fillers intended to saturate the backing and provide a surface to which the maker coat will bond tightly. Hence binders with a very significant amount of filler are typically used. The filler is a necessary component to reduce the cost, block the passages within the fabric to reduce its porosity and to modify the physical properties of the backing. In particular, the addition of filler improves the modulus of the cured formulation and at the same time reduces the amount of the (usually expensive) polymer-forming components that comprise the binder. The presence of heavy filler loadings is very unfavorable to the use of UV-radiation curable binders. UV radiation cannot penetrate far enough because of the shadowing effect of the filler particles.

Similar problems arise when a maker or size coat comprising filler particles is used.

The advantages of UV cure in terms of speed of cure and versatility of formulation properties are well-known. It would therefore be a distinct advantage if this shadowing effect of filler particles could be eliminated.

The present invention provides a way to secure the beneficial results of adding filler without impeding the rate of cure of a UV-curable binder significantly.

### SUMMARY OF THE INVENTION

The present invention provides a coating composition comprising a UV-polymerizable formulation and from 5 to 50% by volume of aluminum trihydrate filler having a particle size of from 1 to 10 micrometers.

The UV light that is used to initiate polymerization has a wavelength of from about 250 to about 400 nm. A filler is considered for the purposes of this Specification to be transparent to this light if, when a formulation containing a UV-polymerizable component and 25% by volume of the filler is exposed to UV light the depth of cure obtained is greater than 50%, and more preferably more than 75% of the depth attained when the formulation without the filler receives the same amount of radiation.

The depth of cure is measured by depositing the formulation on a belt surface passing under a UV source at a predetermined rate such the formulation receives the same amount of exposure. The result is the formation of a thin crust on the surface of the formulation. The thickness of this crust is an excellent measure of the relative depth of penetration of the UV radiation with various loading levels and types of filler.

The most frequently used fillers are calcium carbonate and silica and these are found to have a quite low transparency to UV light. Consequently the use of these fillers severely restricts the thickness of layers that can be cured. The present invention follows from the discovery that certain known filler materials have an unexpected superiority to the others when used with UV-curable formulations. Not only do they perform very well in improving the modulus of the cured formulation, but surprisingly, because they are UV-transparent, they permit the cure of much greater thicknesses than is possible if alternative fillers are used.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a chart showing the depth of cure obtained using various fillers in various proportions when incorporated into a UV-curable formulation.

FIGS. 2 and 3 show, respectively, the same depth of cure charts with 100 and 150 feet/minute (30.8 and 46.2 meters/minute respectively) rates of passage beneath the UV source. The legend on the chart appearing as FIG. 1 applies also to FIGS. 2 and 3.

FIG. 4 shows the increase in Knoop hardness of various formulations comprising increasing amounts of filler in the same binder. Again the legend from FIG. 1 applies to this chart also.

FIG. 5 shows the depth of cure plotted against the volume percentage of ATH in a commercial epoxyacrylate oligomer/monomer blend, at various line speeds.

### DETAILED DESCRIPTION OF THE INVENTION

A description of example embodiments of the invention follows.

The UV-curable component of the formulations of the invention include any of those taught in the art as being useful for the production of coated abrasives including acrylated epoxy resins, urethane acrylates, acrylated epoxy-novolacs, unsaturated polyesters, polyvinyl ethers and the like. The preferred binders of the invention comprise acrylated epoxy resins and urethane acrylates.

The particle size of the aluminum trihydrate filler, which as used in this specification is understood to refer to the weight average particle size, is from about 1 to 10μ. The most preferred aluminum trihydrate has a particle size of from about 1 to about 7μ.

The volume of filler that may be present in the compositions of the invention can be from about 5 to about 50% by volume and more preferably is from about 25 to about 50% by volume. Modulus improves up to the maximum packing fraction for the particular filler. This is generally dependent on the particle size and shape.

Because the UV-polymerizable component has the primary function of providing a bonding layer, it is possible to approach the maximum packing fraction without significantly impairing the important physical characteristics of the cured formulation. Hence amounts of filler in the upper reaches of the above range are often preferred, for example from about 30 to 40 volume percent.

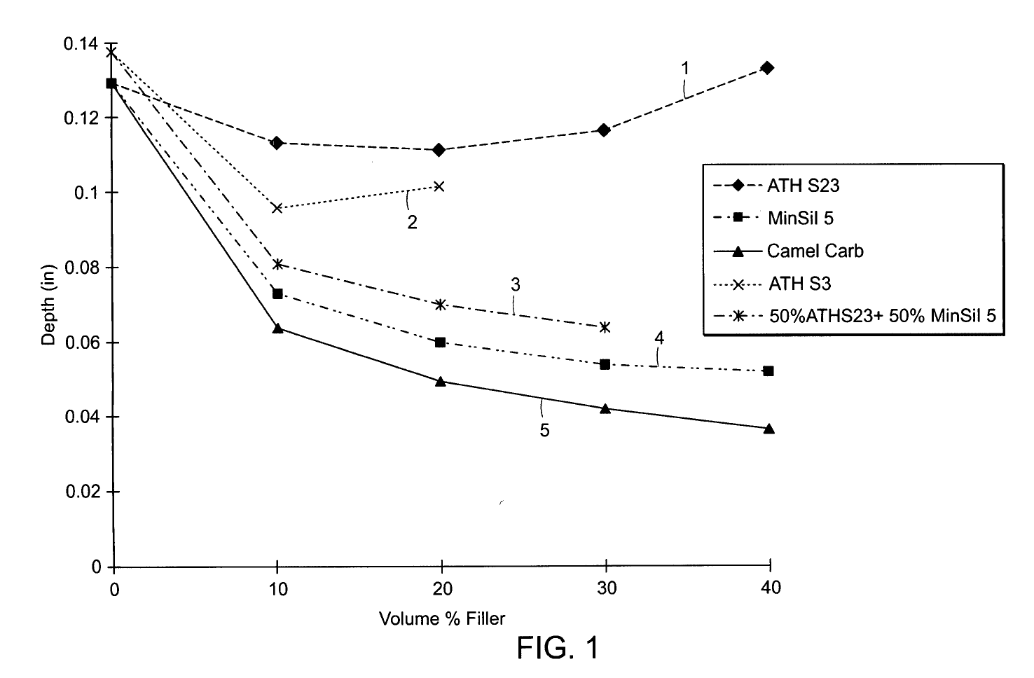

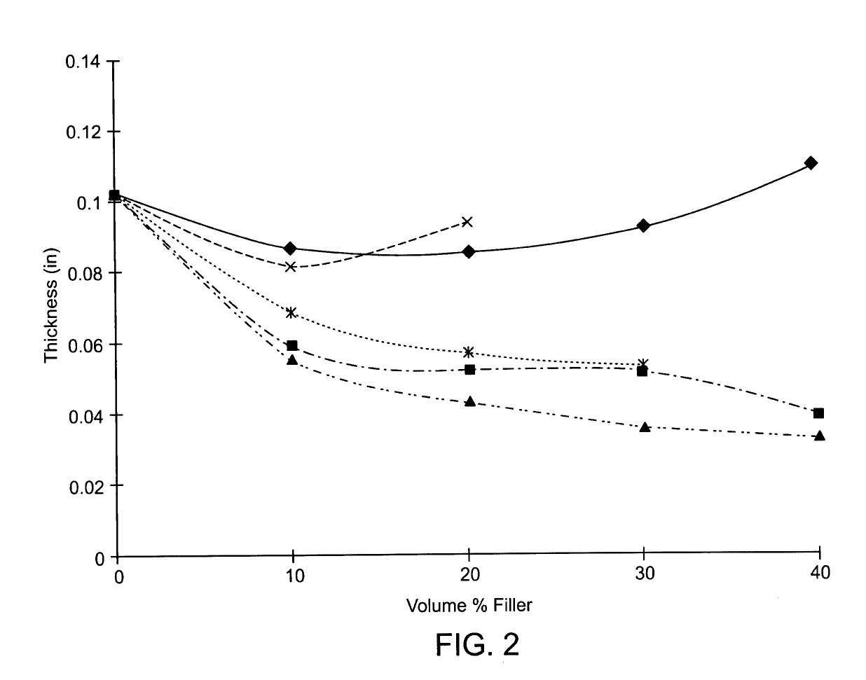

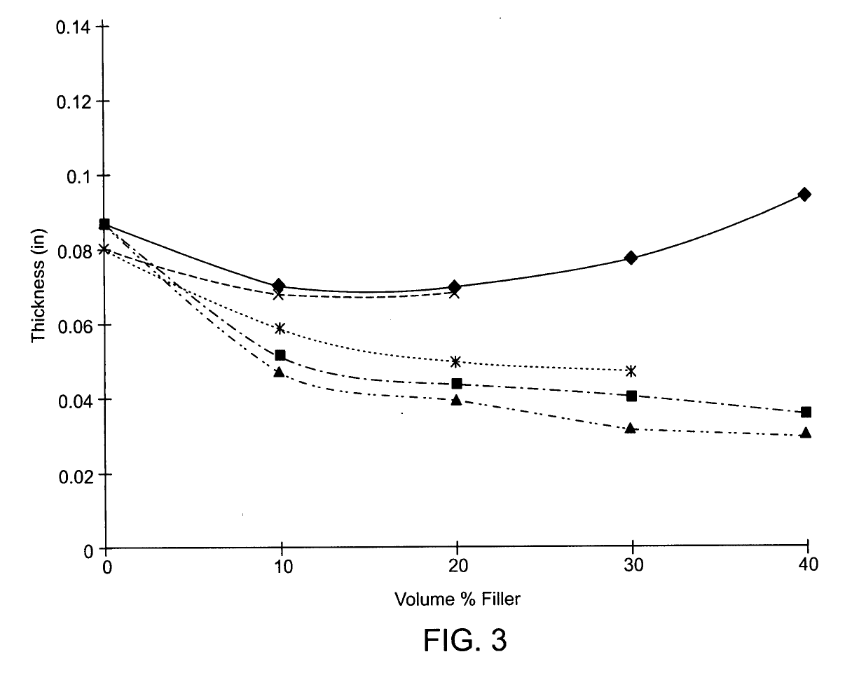

The invention is now described with reference to the data presented in the Drawings. These data are intended as illustrations of the invention and are not to be taken a implying any limitations on the necessary scope of the invention. FIGS. 1 to 3 show clearly that, with conventional fillers such as calcium carbonate or silica, the depth of cure continues to decline with increasing amounts of filler. However with aluminum trihydrate, after an initial decline, the cure depth actually begins to increase with increasing concentration of filler. In these experiments the binder comprised an epoxyacrylate (70%)/N-vinyl pyrrolidone (30%) mixture.

The formulations were passed beneath a UV source at a linear speed of 50 feet/minute, (15.4 meters/min). The boehmite experiment operated at a slower speed which accounts for the greater initial cure depth, (at zero concentration).

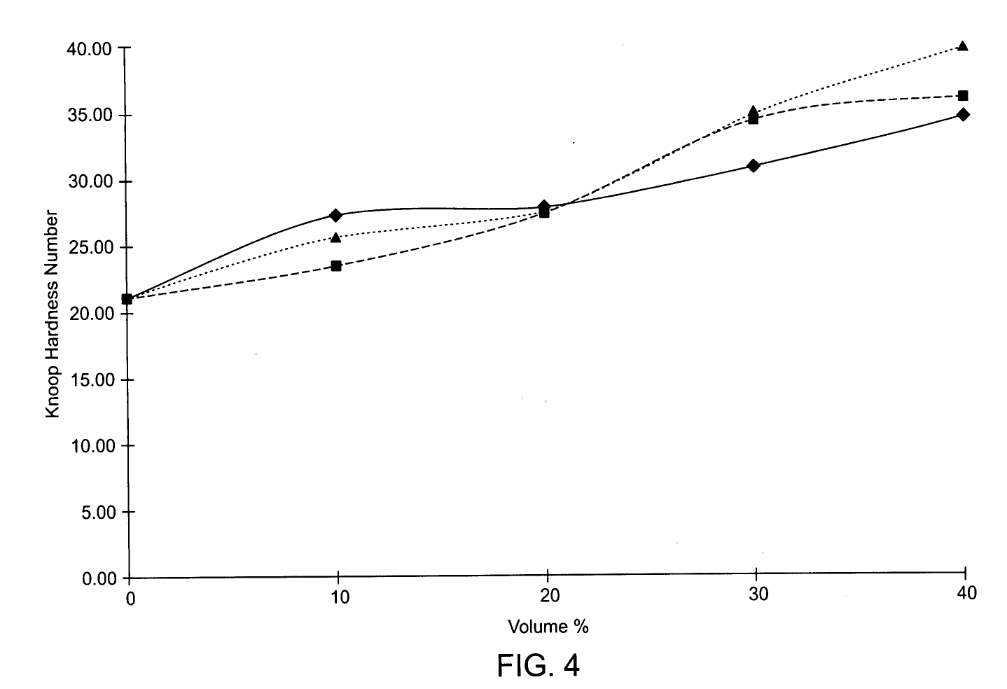

FIG. 4 shows that the various fillers produce very similar levels of improvement in the hardness of the formulation when cured.

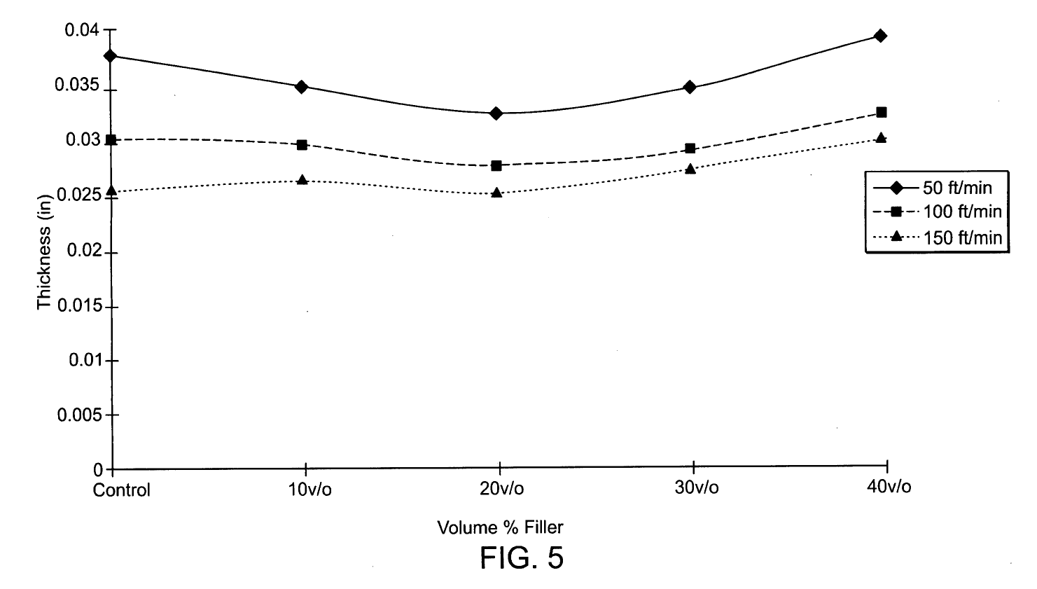

FIG. 5 As might be anticipated, this drawing shows that the depth of cure decreases with increasing line speed which translates to shorter exposure time to the UV radiation. However, unexpectedly, the effect of the presence of the filler is markedly less when higher line speeds are used. It is also somewhat surprising that, at all speeds, volume proportions of filler above about 30% actually increase the depth of cure.

In FIGS. 1-4 the characteristics of five different formulations are described. These differ only in the nature of the filler and the different fillers are identified as follows:

ATH S23 . . . aluminum trihydrate with a weight average particle size of 7.5μ.

ATH S3 . . . aluminum trihydrate with a weight average particle size of 1μ available from Alcoa Industrial Chemicals.

MinSil 5 . . . an amorphous fused silica with a weight average particle size of 7μ, available from Minco Inc.

Camel Carb . . . a calcium carbonate with a weight average particle size of 7.5μ, available from Global Stone PenRoc Inc.

Boehmite . . . an alpha alumina monohydrate available from Condea under the trade name Disperal.

50% ATH-S23+50% MinSil 5 . . . As the name implies this is a mixture of equal volumes of the indicated components.

As indicated above, the products evaluated in FIG. 5 used the preferred aluminum trihydrate with a different binder from that used in the other formulations evaluated.

Consideration of the data in FIGS. 1 to 3 clearly shows that the depth to which the UV radiation is able to penetrate (and thus lead to cure) is significantly greater with the hydrated aluminas than with the more conventional fillers. Since this improvement can be obtained with no significant sacrifice in the physical properties of the resulting cured material, (from FIG. 4), it is clear that the use of UV-transparent fillers such as aluminum trihydrate is a very desirable expedient.

While this invention has been particularly shown and described with references to example embodiments thereof, it will be understood by those skilled in the art that various changes in form and details may be made therein without departing from the scope of the invention encompassed by the appended claims.

What is claimed is:

1. The coated abrasive comprising a cured layer of the coating composition that comprises:
an ultraviolet-polymerizable formulation; and
a filler, wherein the filler:
is in an amount from about 5 to about 50% by volume;
is of a weight average particle size between about 1 micrometer and about 10 micrometers; and
is transparent to ultraviolet light.

2. The coated abrasive of claim 2, wherein the filler is an amount from 25% to 50% by volume of the composition.

3. The coated abrasive of claim 2, wherein the filler is in an amount from about 30% to about 40% by volume.

4. The coated abrasive of claim 1, wherein the weight average particle size of the filler is from about 1 micrometer to about 7.5 micrometers.

5. The coated abrasive of claim 1, wherein the particle size is from 1 to 7 micrometers.

6. The coated abrasive of claim 2, wherein the ultraviolet-polymerizable formulation is selected from the group consisting of epoxyacrylates, urethane acrylates, acrylated epoxy-novolacs, unsaturated polyesters, and polyvinyl ethers.

7. The coated abrasive of claim 6, wherein the ultraviolet-polymerizable formulation comprises an epoxyacrylate.

8. The coated abrasive of claim 1, wherein the filler consists essentially of aluminum trihydrate.
